(19) United States
(12) Patent Application Publication
(10) Pub. No.: US 2025/0164344 A1
(43) Pub. Date: May 22, 2025

(54) SYSTEM FOR MEASURING THE FATIGUE OF A MECHANICAL STRUCTURE

(71) Applicants: Safran, Paris (FR); Safran Seats, Plaisir (FR)

(72) Inventors: Raed Bsili, Moissy-Cramayel (FR); Rafik Hadjria, Moissy-Cramayel (FR)

(21) Appl. No.: 18/843,030

(22) PCT Filed: Mar. 1, 2023
(86) PCT No.: PCT/EP2023/055126

§ 371 Date: Aug. 30, 2024

(30) Foreign Application Priority Data
Mar. 7, 2022 (FR) 2201932

(51) Int. Cl. G01M 5/00; B64D 11/06; G01M 99/00

(52) U.S. Cl. CPC G01M 5/0041; B64D 11/06; G01M 99/001

(57) ABSTRACT

The invention relates to a system for measuring the fatigue of a mechanical structure, comprising:
a first force sensor capable of generating a first signal representative of a force applied to a first mechanical part of the mechanical structure;
a second force sensor capable of generating a second signal representative of a force applied to a second mechanical part of the mechanical structure; and
an electronic processing module configured to calculate a correlation coefficient between the first signal and the second signal, and to indicate a state of fatigue of the mechanical structure as a function of a temporal change in the previously calculated correlation coefficient.

The present invention relates to a system for measuring the fatigue of a mechanical structure. The invention finds a particularly advantageous, but not exclusive, application with aircraft seats. However, the invention could also be implemented with seats for other means of transport, such as for example seats for motor vehicles, trains, or boats and more generally with any mechanical system in which at least two parts are mechanically linked together.

Safety rules require airlines to monitor the fatigue of aircraft seat parts, insofar as they are subjected to strong mechanical stresses (or loads). Seats are therefore subject to revision (or maintenance) on a regular and recurring basis. In addition, for reasons linked to the brand image of the airline and the equipment manufacturer, it is important to set up in-situ monitoring of the physical state of the seat parts.

During a maintenance phase, the cabin of an aircraft is inspected in order to detect possible malfunctions. Some seat defects are not easily visible to the naked eye and may require functional tests which may take time to complete.

Furthermore, when a fault is not detected or is detected late by maintenance teams, on-board staff, or in the worst case by a passenger, this can lead to passenger dissatisfaction, a poor image of the airline, or excessive maintenance time because replacement of the part could not be anticipated.

The objective of the invention is to effectively remedy this drawback by proposing a system for measuring the fatigue of a mechanical structure comprising:
a first force sensor capable of generating a first signal representative of a force applied to a first mechanical part of the mechanical structure,
a second force sensor capable of generating a second signal representative of a force applied to a second mechanical part of the mechanical structure, and
an electronic processing module configured to calculate a correlation coefficient between the first signal and the second signal, and to indicate a state of fatigue of the mechanical structure as a function of a time evolution of the previously calculated correlation coefficient.

The invention thus allows, thanks to the analysis of the correlation coefficient between the two signals generated by the force sensors integrated in the articulated structure, to automatically detect a malfunction of a mechanical part even before the occurrence thereof.

According to one embodiment of the invention, the first signal and the second signal are acquired over a plurality of acquisition periods each corresponding to an operating cycle, the correlation coefficient between the first signal and the second signal being calculated over each acquisition period.

According to one embodiment of the invention, the electronic processing module is configured to determine mathematical indicators for each signal over each acquisition period, such as an average, a minimum, a maximum, a standard deviation.

According to one embodiment of the invention, the electronic processing module is configured to calculate the correlation coefficient only when a load variation is detected by the first force sensor and/or the second force sensor.

According to one embodiment of the invention, the load variation is detected when a standard deviation and/or a time derivation of the first signal and/or the second signal is greater than a predetermined threshold.

According to one embodiment of the invention, the calculated correlation coefficient is chosen from the Pearson coefficient or the Spearman coefficient or is obtained from a cross-correlation.

According to one embodiment of the invention, the first force sensor and the second force sensor are strain gauges.

The invention also relates to an aircraft seat comprising:
a mechanical structure comprising a backrest associated with a connecting part as well as a bracket on which the connecting part is fixed, and
a fatigue measurement system as previously defined.

According to one embodiment of the invention, the first force sensor is placed on the bracket and the second force sensor is placed on the connecting part.

According to one embodiment of the invention, the connecting part is mounted on the bracket via a pivot connection.

According to one embodiment of the invention, said aircraft seat further comprises an armrest mounted on the bracket, the first force sensor being arranged on the bracket and the second force sensor being arranged on the armrest.

According to one embodiment of the invention, said aircraft seat further comprises a meal table rotatably mounted relative to the backrest, the first force sensor being arranged on the backrest and the second force sensor being arranged on the bracket.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

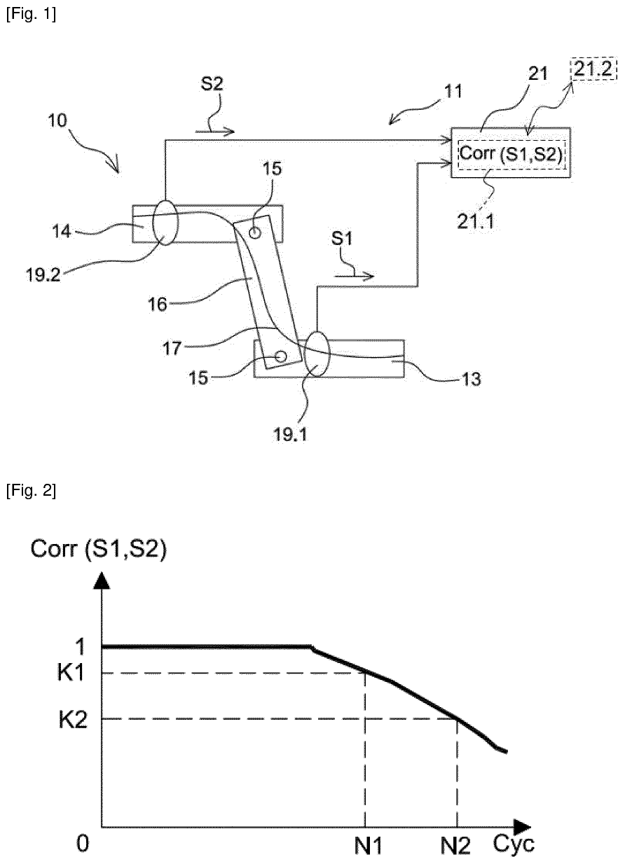

FIG. 1 is a schematic representation of a structure mechanics in which a fatigue measurement system is integrated;

FIG. 2 is a graphic representation of the evolution, in function of a number of operating cycles of the mechanical structure, of a correlation coefficient between the two signals from the force sensors integrated in parts of said mechanical structure;

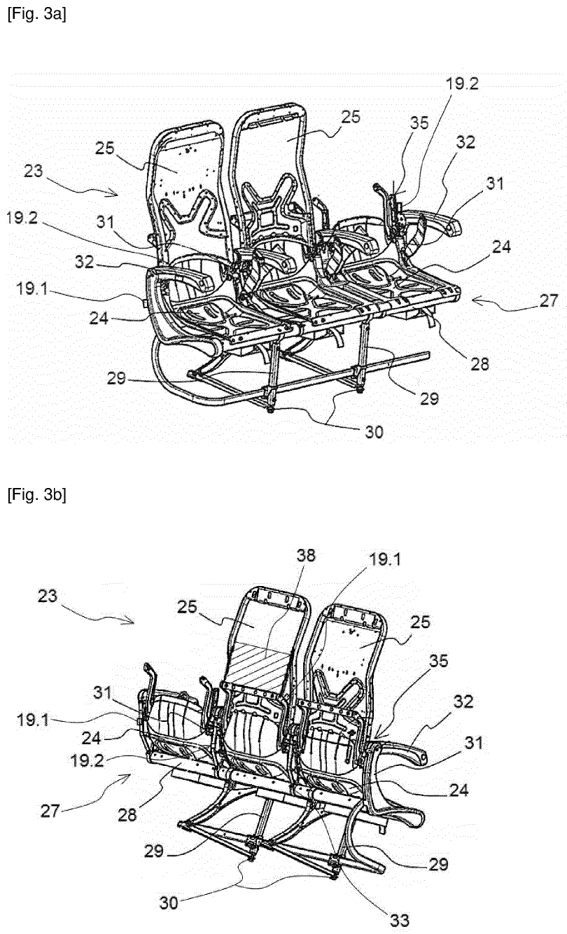

FIGS. 3a and 3b are front and rear perspective views of an aircraft seat incorporating a fatigue measurement system according to the present invention;

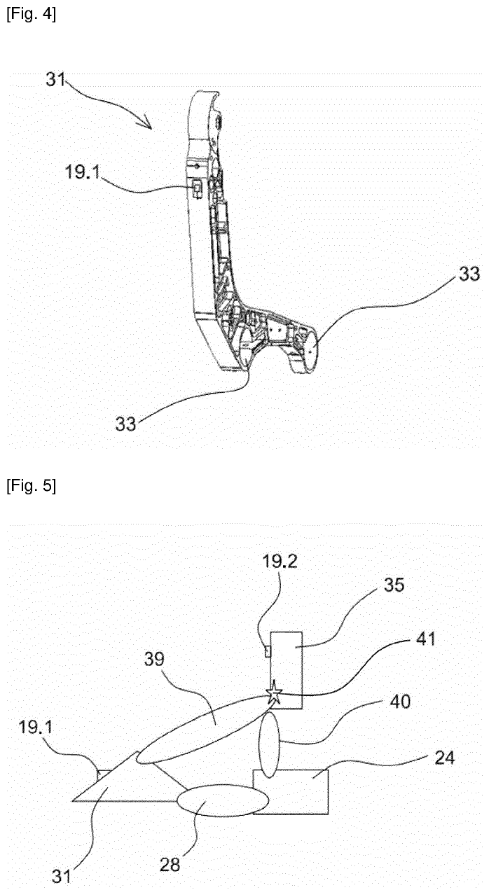

FIG. 4 is a perspective view illustrating the integration of a force sensor in a bracket of the seat in FIGS. 3a and 3b;

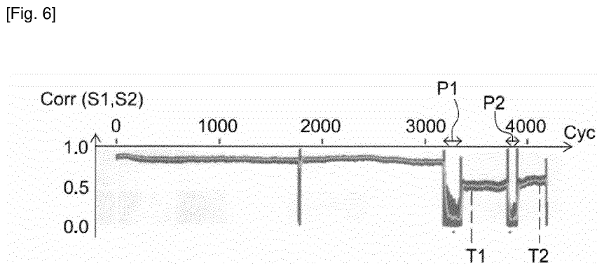

FIG. 5 is a schematic representation of the structure mechanics between the connecting part of a backrest and the bracket of the seat in FIGS. 3a and 3b;

FIG. 6 is a graphic representation of the evolution, in function of a number of operating cycles of the backrest, of a correlation coefficient between the signals from the force sensors integrated respectively in the fixing element of a backrest and the bracket of the seat in FIGS. 3a and 3b.

It should be noted that, in the figures, the structural elements and/or functionalities common to the different embodiments may have the same references. Thus, unless otherwise stated, such elements have identical structural, dimensional and material properties.

FIG. 1 shows a mechanical structure 10 on which a fatigue measurement system 11 is installed. The mechanical structure 10 comprises at least a first mechanical part 13 and a second mechanical part 14 mechanically connected to each other. The mechanical connection(s) 15 between the mechanical parts 13, 14 may be rigid connections, that is to say connections 15 without any degree of freedom, or connections 15 having at least one degree of freedom in rotation, such as for example a pivot connection. Thus, the mechanical part 13 can notably be mounted so as to be movable in rotation or fixed relative to the mechanical part 14.

The mechanical structure 10 is capable of transmitting a force through a force transmission chain 17 between the first part 13 and the second end part 14. One or more intermediate parts 16 ensure the transmission of the force from the first end part 13 to the second end part 14 through the force transmission chain 17. According to some embodiments, there is no intermediate part 16 between the first mechanical part 13 and the second mechanical part 14 of the mechanical structure 10, which are then directly mechanically connected to each other via one or more mechanical connections 15.

The fatigue measurement system 11 comprises a first force sensor 19.1 arranged on the first mechanical part 13 and a second force sensor 19.2 arranged on the second mechanical part 14. The first force sensor 19.1 is capable of generating a first signal S1 representative of a force applied to the first mechanical part 13 of the mechanical structure 10. The second force sensor 19.2 is capable of generating a second signal S2 representative of a force applied to the second mechanical part 14 of the mechanical structure 10.

The first force sensor 19.1 and the second force sensor 19.2 are preferably analog sensors, such as strain gauges. These piezoresistive type gauges allow the deformation of a part to be converted into variation in electrical resistance (the more the extensometers stretch, the more their resistance increases). These gauges comprise closely spaced turns and are generally made from a thin metal sheet (a few micrometers thick) and an electrical insulator. Alternatively, it is possible to use a vibration sensor or any other type of sensor adapted to the application such as a force sensor based on carbon nanotubes which could be integrated into a composite material part of the structure mechanical. A nanotube-based sensor comprises a plurality of very dense fullerenes having a very low weight. The nanotube-based sensor can be placed on an external face of the part or integrated inside the composite material of the part. As soon as the part is subjected to stress, the electrical resistance of the nanotube-based sensor is modified. The sensor generates a signal, in particular a current signal, representative of this variation in electrical resistance and therefore of the level of effort applied to the part.

In the event that the cabin temperature is subject to a variation between acquisitions, resistive sensors having a Wheatstone bridge configuration can be used to compensate for this variation in the measured signal. Other numerical methods can be used to correct measurement errors induced by thermal variations.

The fatigue measurement system 11 also includes an electronic processing module 21 to which the first force sensor 19.1 and the second force sensor 19.2 are electrically connected. The connection between the electronic processing module 21 and the force sensors 19.1, 19.2 can be made via a wired connection or a wireless connection. The electronic processing module 21 may take the form of a standard microcontroller comprising a microprocessor and memories. The electronic processing module 21 may be an autonomous module including a rechargeable battery, a cell, a super-capacitor or any other source of electrical energy adapted to the application.

The electronic processing module 21 acquires the first signal S1 and the second signal S2 over a plurality of acquisition periods each corresponding to an operating cycle of the mechanical structure 10.

The electronic processing module 21 is configured to calculate a correlation coefficient between the first signal S1 and the second signal S2 over each acquisition period. An acquisition period is for example between 5 s and 30 s and is preferably about 20 s.

The electronic processing module 21 is also configured to determine mathematical indicators for each signal over each acquisition period such as in particular an average, a minimum, a maximum, and a standard deviation.

The electronic processing module 21 is also configured to calculate a correlation coefficient Corr(S1, S2) between the first signal S1 and the second signal S2. The correlation coefficient Corr(S1, S2) is representative of the mechanical transfer, between the two parts 13, 14, of the force(s) applied to each part 13, 14 independently of the force levels applied to each part 13, 14. The coefficient correlation Corr(S1, S2) calculated is preferably chosen from the Pearson coefficient or the Spearman coefficient or is obtained from a cross-correlation. Alternatively, however, it would be possible to use any other correlation coefficient adapted to the application.

The electronic processing module 21 is capable of indicating a state of fatigue for the mechanical structure 10 as a function of a time evolution of the correlation coefficient Corr(S1, S2) previously calculated.

Preferably, the electronic processing module 21 is configured to calculate the correlation coefficient Corr(S1, S2) only when a load variation is detected by the first force sensor 19.1 and/or the second force sensor 19.2. The load variation is detected when a standard deviation and/or a time derivation of the first signal S1 and/or the second signal S2 is greater than a predetermined threshold.

Alternatively, the electronic processing module 21 may include a first local processing sub-module 21.1 for calculating the mathematical indicator(s), in particular the correlation coefficient Corr(S1, S2). The electronic processing module 21 comprises a second remote processing sub-module 21.2, such as a remote software platform. According to this embodiment, the aforementioned analysis of the time evolution of the correlation coefficient Corr(S1, S2) to deduce the state of fatigue for the mechanical structure 10 can be carried out by the remote software platform 21.2 on the basis of the mathematical indicators calculated by the first processing sub-module 21.1.

FIG. 2 shows the evolution of the correlation coefficient Corr(S1, S2) as a function of the number of operating cycles Cyc of the mechanical structure 10. At the start of the use of the mechanical structure 10, the force applied on one of the mechanical parts 13, 14 are mechanically transmitted optimally to the other mechanical part 13, 14 via the force transmission chain 17. The correlation coefficient Corr(81, 82) is then maximum.

When the electronic processing module 21 detects, after a number of operating cycles N1, that the correlation coefficient Corr(S1, S2) becomes lower than a fatigue limit threshold K1, this means that the force is no longer transmitted optimally and therefore that the mechanical structure begins to get fatigue. This thus induces discomfort in the case when the mechanical structure 10 belongs to a piece of furniture, such as a seat or a bed for a person.

When the electronic processing module 21 detects, after a number of operating cycles N2, that the coefficient becomes less than a breakage threshold K2, this means that a part of the mechanical structure 10 is broken. Breakage can occur on the first part 13, the second part 14, or possibly an intermediate part 16 of the mechanical structure 1a. In other words, the fatigue measurement system allows to detect the malfunction of any part located in the force transmission chain between the two parts 13, 14 on which the force sensors 19.1, 19.2 are arranged.

The electronic processing module 21 may deliver an alert signal, for example a light signal and/or a sound signal, when detecting that the correlation coefficient Corr(S1, S2) falls below the fatigue limit threshold K1. An alert signal can also be delivered when the electronic processing module 21 detects that the correlation coefficient Corr(S1, S2) falls below the breakage threshold K2. However, the interest of the invention is to alert the user before the actual breakage of a part of the mechanical structure 1a. The fatigue limit threshold KI, and where applicable the breakage threshold K2, are predetermined during preliminary tests for the mechanical structure whose state of fatigue must be controlled over time.

FIGS. 3a and 3b illustrate the integration of a system for measuring the fatigue 11 according to the invention in a seat 23 to be installed in an aircraft cabin. The aircraft seat 23 comprises at least one seating surface 24 and at least one backrest 25 defining a seating place. In this case, the seat 23 has three seating surfaces 24 and three backrests 25 defining three seating places. This number of places can of course be adapted according to need.

The seating surfaces 24 and the backrests 25 are mounted on a seat structure 27. This seat structure 27 includes transverse reinforcement beams 28. Support feet 29 are intended to support the seating surface 24. These support feet 29 are provided with locks 30 to ensure the clamping of the seat 23 on rails (not shown) on the floor of the aircraft cabin.

Brackets 31 are arranged between the seating surfaces 24 as well as at the ends of the seat 23. These brackets 31 have an L-shape and include passage openings 33 for the transverse reinforcement beams 28, as illustrated in FIG. 4. These brackets 31 carry armrests 32. These armrests 32 can be mounted so as to be movable in rotation relative to the brackets 31 between a raised position and a lowered position.

A backrest 25 can be mounted on the bracket 31 via a connecting part 35, in particular a connecting rod. The connecting part 35 is mounted on the bracket 31 via a pivot connection. The backrest 25 is then movable in rotation relative to the bracket 31 between a raised position also called TTL (for Taxi, Take-off, Landing) position and a relaxed position in which the backrest 25 is inclined backwards. Alternatively, the backrest 25 can be mounted so as to be fixed relative to the bracket 31.

The seat 23 may also include a tray table 38 visible in FIG. 3b mounted s as to be movable in rotation between a stored position in which the tray table 38 is pressed against a rear face of the backrest 25 in a substantially vertical plane and a deployed position in which the tray table 38 extends in a substantially horizontal plane.

Some parts of the seat 23, in particular the seating surface 24 and the backrest 25, may be covered with cushions (not shown) in order to improve the comfort of the passenger.

FIG. 5 illustrates a mechanical structure 10 formed by the connecting part 35 fixed to the bracket 31 via a fixing member 39, such as a screw or a rivet. The bracket 31 is mechanically linked to the seating surface 24 via a reinforcing beam 28.

In order to control the fatigue of this structure 10, the first force sensor 19.1 could be placed on the bracket 31. As illustrated in FIG. 4, the force sensor 19.1 could be placed on the rear face of the bracket 31. The second force sensor 19.2 can be placed on the connecting part 35 (see FIG. 3a). One or more additional parts 40 also ensure a force transmission between the seating surface 24 and the connecting part 35.

FIG. 6 shows the evolution of the correlation coefficient Corr(S1, S2) between the signals S1, S2 returned by the force sensors 19.1, 19.2 as a function of the number of operating cycles Cyc. According to this implementation example, a operating cycle Cyc consists of applying a variable load to the backrest 25 for twenty seconds then stopping the application of this variable load. Of course, when the seat is used by a passenger, the duration of application of the variable load may be different and vary over time.

This figure emphasizes that it is possible to predict a failure 41 at time T1 several hundred operating cycles before it actually occurs. Indeed, the electronic processing module 21 detects that the correlation coefficient falls below the fatigue limit threshold K1 at time T1, while the actual breakage of a part of the mechanical structure 10 occurs at time T2, i.e. 600 operating cycles after time T1.

It should be noted that the periods P1 and P2 are not representative of the state of fatigue of the mechanical structure 10 because no load variation is applied to the backrest 25 during these periods P1 and P2. The correlation coefficient Corr(S1, S2) between the signals S1 and S2 is random over these periods P1 and P2 because of the noise generated in the sensors 19.1, 19.2.

Given that over these periods P1 and P2, the standard deviation and/or the time derivation of the first signal S1 and/or the second signal S2 remains inferior to the predetermined threshold, the correlation coefficient Corr(S1, S2) is preferably not calculated by the system.

According to another embodiment, the first force sensor 19.1 is placed on the bracket 31 and the second force sensor 19.2 is placed on the armrest 32 (see FIG. 3a).

According to another embodiment, the first force sensor 19.1 is placed on the backrest 25 and the second force sensor 19.2 is placed on the bracket 31 (see FIG. 3b).

Of course, the different characteristics, variants and/or embodiments of the present invention can be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A fatigue measurement system for a mechanical structure, the fatigue measurement system comprising:
a first force sensor capable of generating a first signal representative of a force applied to a first mechanical part of the mechanical structure;
a second force sensor capable of generating a second signal representative of a force applied to a second mechanical part of the mechanical structure; and
an electronic processing module configured to calculate a correlation coefficient between the first signal and the second signal, and to indicate a state of fatigue of the mechanical structure according to a time evolution of the correlation coefficient previously calculated.

2. The system according to claim 1, wherein the first signal and the second signal are acquired over a plurality of acquisition periods each corresponding to an operating cycle, the correlation coefficient between the first signal and the second signal being calculated over each acquisition period.

3. The system according to claim 2, wherein the electronic processing module is configured to determine mathematical indicators for each signal over each acquisition period, such as an average, a minimum, a maximum, a standard deviation.

4. The system according to claim 1, wherein the electronic processing module is configured to calculate the correlation coefficient only when a load variation is detected by the first force sensor and/or the second force sensor.

5. The system according to claim 4, wherein the load variation is detected when a standard deviation and/or a time derivation of the first signal and/or the second signal is greater than a predetermined threshold.

6. The system according to claim 1, wherein the calculated correlation coefficient is chosen from the Pearson coefficient or the Spearman coefficient or is obtained from a cross-correlation.

7. The system according to claim 1, wherein the first force sensor and the second force sensor are strain gauges.

8. An aircraft seat comprising:
a mechanical structure comprising a backrest associated with a connecting part as well as a bracket to which the connecting part is fixed; and
a fatigue measurement system as defined according to claim 1.

9. The aircraft seat according to claim 8, wherein the first force sensor is arranged on the bracket and the second force sensor is arranged on the connecting part.

10. The aircraft seat according to claim 8, further comprising an armrest mounted on the bracket, the first force sensor being arranged on the bracket and the second force sensor being arranged on the armrest.

11. The aircraft seat according to claim 8, further comprising a tray table rotatably mounted relative to the backrest, the first force sensor being arranged on the backrest and the second force sensor being arranged on the bracket.

12. An aircraft equipped with aircraft seats according to claim 8.
